(19) United States
(12) Patent Application Publication
(10) Pub. No.: US 2018/0192136 A1
(43) Pub. Date: Jul. 5, 2018

(54) Device, System, and Method for Generating Share-Weighted Indices

(71) Applicant: Viacom International Inc., New York, NY (US)

(72) Inventor: Brandon GRABOWSKI, New York, NY (US)

(21) Appl. No.: 15/398,404

(22) Filed: Jan. 4, 2017

(51) Int. Cl. H04N 21/466; H04N 21/442; H04N 21/81; H04N 21/45

(52) U.S. Cl. CPC H04N 21/4667; H04N 21/4532; H04N 21/812; H04N 21/44218

(57) ABSTRACT

A device, system, and method generates share weighted indices. The method performed in an analysis server includes determining a share value and an index value for an attribute of a target audience, the share value indicative of a percentage that the target audience occupies in a population, the index value indicative of a likelihood that the target audience has the attribute. The method includes determining a scaled index value based on the index value, the scaled index value being determined with a first formula when the index value is below a predetermined threshold index value, the scaled index value being determined with a second formula when the index value is above the predetermined threshold index value. The method includes determining a share-weighted index value based on the share value and the scaled index value.

### BACKGROUND INFORMATION

Media content may be broadcast in a variety of ways. A conventional way of broadcasting media content is through a television. The television may utilize a broadcast signal received from a distributor such as a programming provider or multichannel video-programming distributor (MVPD). The distributor may receive media content from one or more producers. Viewers may tune into one or more of the broadcast signals to view the respective content.

There are various systems and devices utilized in gathering information regarding the playback of the media content by televisions. Thus, in a first aspect, the systems and devices may utilize the playback information to track television programs that are being watched by audiences. The playback information may also track a viewing behavior of the audience. The viewing behavior may be associated with profiles of each member of the audience where the profiles include demographic information. Accordingly, in a second aspect, the systems and devices may utilize the playback information to track who or which demographic is watching a particular television program.

The playback information may relate to a target audience attribute among a plurality of television programs or for a demographic watching a particular television program. The target audience attribute may be displayed as a share or an index. The share may represent a percentage of a target audience to which the attribute applies, whereas the index may represent a likelihood that a target audience is to have the attribute compared to a total population. However, the share may miss important attributes that may be smaller but better define the target audience while the index may highlight relationships that may not be meaningful or useful.

### SUMMARY

The exemplary embodiments are directed to a method, comprising: in an analysis server: determining a share value and an index value for an attribute of a target audience, the share value indicative of a percentage that the target audience occupies in a population, the index value indicative of a likelihood that the target audience has the attribute; determining a scaled index value based on the index value, the scaled index value being determined with a first formula when the index value is below a predetermined threshold index value, the scaled index value being determined with a second formula when the index value is above the predetermined threshold index value; and determining a share-weighted index value based on the share value and the scaled index value.

The exemplary embodiments are directed to an analysis server, comprising: a transceiver receiving a share value and an index value for an attribute of a target audience, the share value indicative of a percentage that the target audience occupies in a population, the index value indicative of a likelihood that the target audience has the attribute; and a processor determining a scaled index value based on the index value, the scaled index value being determined with a first formula when the index value is below a predetermined threshold index value, the scaled index value being determined with a second formula when the index value is above the predetermined threshold index value, the processor determining a share-weighted index value based on the share value and the scaled index value.

The exemplary embodiments are directed to a method, comprising: in an analysis server: determining a share value and an index value for an attribute of a target audience, the share value indicative of a percentage that the target audience occupies in a population, the index value indicative of a likelihood that the target audience has the attribute; determining a scaled index value based on the index value, the scaled index value being determined with a first formula when the index value is below a predetermined threshold index value, the scaled index value being determined with a second formula when the index value is above the predetermined threshold index value; and determining a share-weighted index value based on the share value and the scaled index value, wherein, when the index value is 100, the scaled index value is set to 0.01 when the share value is above a predetermined threshold share value, and wherein, when the index value is between 80 and 100, the scaled index value is set to an absolute value thereof.

### BRIEF DESCRIPTION OF THE DRAWINGS

FIG. 1 shows a system according to the exemplary embodiments.

FIG. 2 shows an analysis server of FIG. 1 according to the exemplary embodiments.

FIG. 3 shows a table of share-weighted index values according to the exemplary embodiments.

FIG. 4 shows a table of modified scaled index values according to the exemplary embodiments.

FIG. 5 shows a method of determining share-weighted index values according to the exemplary embodiments.

### DETAILED DESCRIPTION

The exemplary embodiments may be further understood with reference to the following description and the related appended drawings, wherein like elements are provided with the same reference numerals. The exemplary embodiments are related to a device, system, and method for generating share-weighted index values for a target audience attribute. Specifically, the exemplary embodiments provide a mechanism in which a share and an index for a target audience are combined into a share-weighted index value. As will be described in further detail below, the share-weighted index value provides a more meaningful perspective to represent the target audience attribute for the target audience.

The viewing behavior of an audience provides invaluable information to various outlets. For example, the viewing behavior may indicate (1) what shows are being watched by the audience, (2) for how long these shows are being watched, and (3) the demographic distributions of the audience for these shows. To represent the audience (e.g., the population of the United States), a system may sample an entire audience or only a subset of the audience. For example, approximately 20,000 households consisting of about 110,000 respondents may be used to represent the audience. The system may utilize various features such as a dynamic weight for each respondent. The dynamic weight may be regularly adjusted to ensure that the data corresponding to the respondent's viewing behavior remains demographically representative through the time that the respondent is providing the data. The respondents who provide the data of their viewing behavior are provided specialized hardware that transmit the data to the system.

The data gathered by the system may indicate various types of information, particularly to a target audience attribute associated with a target audience. The target audience may refer to a portion of a population to which a television program is broadcast. In a first example, the data may be used to determine a share of the target audience. Accordingly, the share may be the target audience who is a percentage of the population who have tuned into and watched the television program. When only the share is used, potentially important attributes of the target audience that may be smaller but better define the target audience may be missed. For example, the share information for the television program may indicate that a first ethnicity is 42% of the total audience, a second ethnicity is 20% of the total audience, a third ethnicity is 30% of the total audience, and the remaining 8% of the total audience being other ethnicities. However, an important detail (e.g., as may be described with another target audience attribute such as index) may be missed that the second and third ethnicities are more likely to watch the television program over the first ethnicity. Therefore, the share of the target audience alone may fail to highlight important target audience attributes.

In a second example, the data may be used to determine an index for each portion of the target audience. Accordingly, the index may be how likely each target audience is likely to tune into and watch the television program. When only the index is used, relationships that may not be meaningful or useful may still be highlighted. For example, a first television program may have 21% of the share of the target audience while a second television program may have only 2% of the share of the target audience. However, the second television audience may have a significantly larger index that indicates that the 2% of the target audience is highly likely to tune in and watch the second television program. Therefore, the index alone may overstate relationships. In another example, the index ranges from 0 to infinity where an index of 100 represents a standard likelihood. Therefore, an index of 50 represents a likelihood that is half of the standard likelihood while an index of 200 represents a likelihood that is twice of the standard. However, it is seen that a difference of 50 (from standard to half as likely) and a difference of 100 (from standard to twice as likely) represents the same relative change. Thus, the index may misrepresent relationships.

To overcome the problem of data associated with viewing behavior misrepresenting target audience attributes, the exemplary embodiments provide a mechanism to generate share-weighted index values in which a share value and an index value associated with a target audience is combined such that the share-weighted index value provides a meaningful representation of an attribute. Specifically, the share-weighted index value may be calculated with the index that is refined to a scaled index range to which a product with the share is determined. By assigning a share-weighted index value to a target audience attribute, a list of attributes may be re-ranked with the share-weighted index values that allows an analyst to view which attributes define the target audience or which attributes actively do not describe the target audience.

It is noted that the use of a television program and viewing behavior as an implementation for the share-weighted index values is only exemplary. The exemplary embodiments may be used with any digital content such as online media, live content such as Broadway shows or concerts, etc. The exemplary embodiments may generally be utilized whenever a target portion of a population is studied in comparison to a larger population. For example, the mechanism according to the exemplary embodiments may be utilized whenever optimizing a selection method in models when using top share values and/or top index values is inadequate. In another example, the mechanism according to the exemplary embodiments may be utilized for polling purposes where a survey conducted about attitudes toward a politician may be determined. That is, results for target audiences compared to a larger population for political opinions may be represented through the exemplary embodiments. In a further example, the mechanism according to the exemplary embodiments may be utilized for census-level data (e.g., the national census, a retail outlet reviewing the full population of customer transactions, etc.). In yet another example, the mechanism according to the exemplary embodiments may be utilized for a variety of other types of scenarios where an attribute of a target audience is compared to a larger population such as types of music that a target audience streams, stored media (e.g., DVD) that a target audience owns, a voting history for a target audience, a travel history for a target audience, etc.

It is also noted that the use of the index value and the share value is only exemplary. As described above, the index value and the share value each have issues of misrepresentation, especially when considered alone. However, the exemplary embodiments may be utilized with any measurement of a target audience attribute in which a substantially similar parameter is determined. Accordingly, the use of the index value and the share value may represent any measurement for a target audience attribute upon which the mechanism according to the exemplary embodiments may be leveraged.

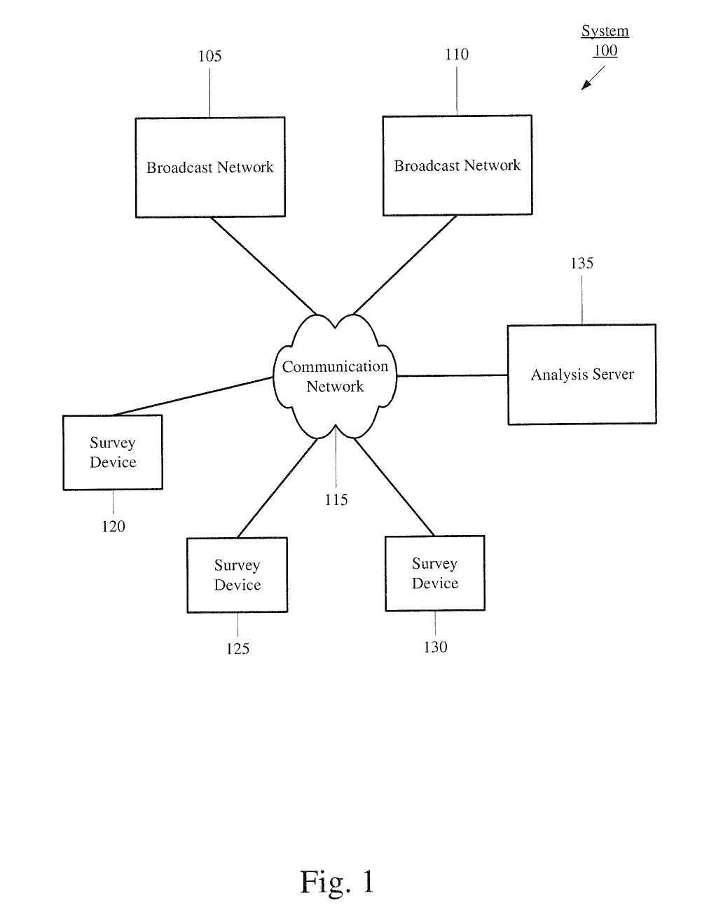

FIG. 1 shows a system 100 according to the exemplary embodiments. The system 100 may utilize features of different distribution models (e.g., a linear distribution model, a non-linear distribution model, etc.) in providing media content or television shows to an audience. More particularly, the shows may be broadcast and tuned into by viewers (e.g., included in a current set of respondents generating data corresponding to viewing behavior). The system 100 may include a plurality of broadcast networks 105, 110, a communication network 115, a plurality of survey devices 120-130, and an analysis server 135. It should be noted that the system 100 is shown with connections between the components. However, those skilled in the art will understand that these connections may be through a wired connection, a wireless connection, interactions between integrated components or software subroutines, or a combination thereof.

The broadcast networks 105, 110 may represent any one or more components associated with broadcasting a television program to an audience. For example, the broadcast networks 105, 110 may include a producer of the show and a distributor of the show (e.g., a network). In a particular embodiment in which a linear distribution model is utilized, a producer may provide a show that is broadcast via a signal by the distributor at a known time for a known duration (e.g., based on a schedule of programming). Thus, the broadcast network 105 may broadcast a plurality of first shows throughout a broadcast day while the broadcast network 110 may broadcast a plurality of second shows throughout the broadcast day.

It should be noted that the system 100 of FIG. 1 illustrates two broadcast networks 105, 110. However, the use of two broadcast networks 105, 110 is only exemplary. Those skilled in the art will understand that there may be any number of broadcast networks each broadcasting a plurality of respective shows throughout the broadcast day. The shows from the broadcast networks may overlap at particular times during the broadcast day. For example, a portion of a first show from the broadcast network 105 may be broadcast at a particular time, a portion of a second show from the broadcast network 110 may also be broadcast at the particular time, a portion of a third show from a further broadcast network may further be broadcast at the particular time, etc.

The communications network 115 may be any type of network that enables data to be transmitted from a first device to a second device where the devices may be a network device and/or an edge device that has established a connection to the communications network 115. For example, the communications network 115 may be a cable provider network, a satellite network, a terrestrial antenna network, the public Internet, a local area network (LAN), a wide area network (WAN), a virtual LAN (VLAN), a Wi-Fi network, a cellular network, a cloud network, a wired form of these networks, a wireless form of these networks, a combined wired/wireless form of these networks, etc. The communications network 115 may also represent one or more networks that are configured to connect to one another to enable the data to be exchanged among the components of the system 100. The communications network 115 may also include network components (not shown) that are configured to perform further functionalities in addition to providing a conduit to exchange data.

The survey devices 120-130 may be an electronic component associated with a television receiver of a respondent. For example, the survey devices 120-130 may be a set meter. A set meter may be a component incorporated or connected to the television receiver that gathers data associated with the viewing behavior of a household and its respondents. The data is then transmitted to a predetermined location. As will be described in further detail below, according to the exemplary embodiments, the data of the viewing behavior may be transmitted to the analysis server 135. However, it should be noted that the system 100 may include further components (e.g., connected to the communication network 115) such as a data repository or entity that gathers the data from the survey devices 120-130. The analysis server 135 may be configured to retrieve the data from the further components.

The set meter may have an identification associated therewith such that the data of the viewing behavior may be transmitted with the identification. The identification may enable the respondent who is associated with the data to be identified. For example, when the household includes only a single respondent, the identification of the set meter may simply identify the respondent. In another example, when the household includes a plurality of respondents, the identification of the set meter may identify the household. The set meter may also be configured to determine or be provided an input that indicates an identity of the respondent. In this manner, the set meter may include further data that is transmitted such as the identity of the respondent along with the identification of the set meter. Accordingly, identification of the respondent may be properly associated with the data of the viewing behavior. The identification of the respondent may be associated with a profile. For example, the profile may include a name, an age, a geo-location, an ethnicity, etc.

It is noted that the exemplary embodiments are described with regard to the respondents utilizing the survey devices 120-130. However, those skilled in the art will understand that there are other manners in which viewing behavior may be provided for analysis. For example, a respondent may manually track what is being watched. Specifically, a respondent may maintain a viewer diary that is transmitted to the analysis server 135.

It is also noted that the system 100 of FIG. 1 shows three survey devices 120-130. However, the use of three survey devices 120-130 is only exemplary. Those skilled in the art will understand that there may be any number of survey devices for each respondent who provides viewing behavior data. In fact, those skilled in the art will appreciate that the exemplary embodiments may provide more insight to viewing behavior via a share value and an index value when the data from a significantly large pool of respondents and/or survey devices is available. Thus, the survey devices 120-130 may represent all the respondents who provide the viewing behavior data or represent the entire population of the audience.

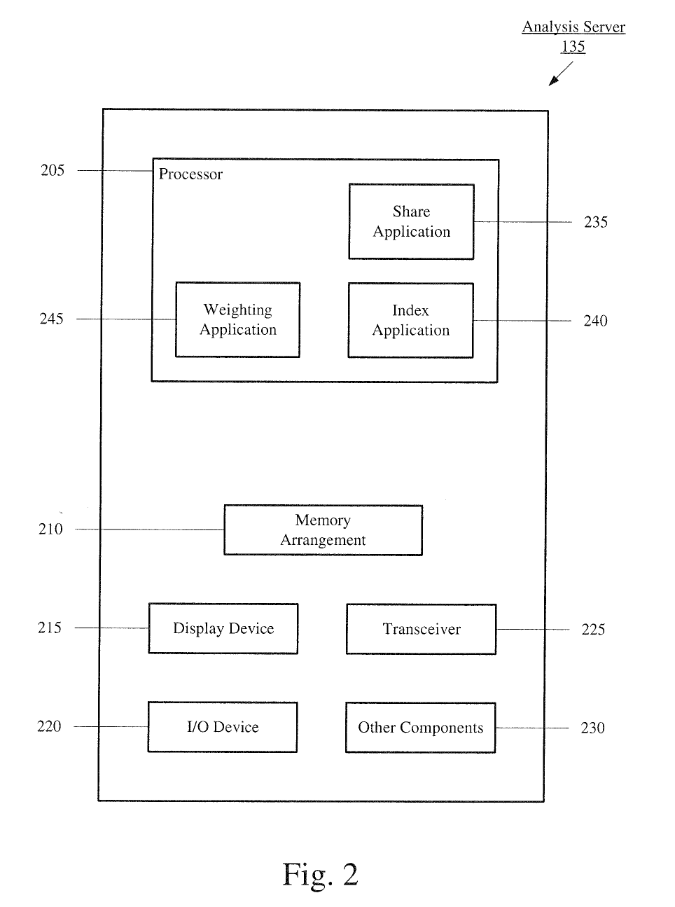

According to the exemplary embodiments, the analysis server 135 may perform a variety of different operations to analyze viewing behavior data gathered from the survey devices 120-130. FIG. 2 shows the analysis server 135 of FIG. 1 according to the exemplary embodiments. The analysis server 135 may include a processor 205, a memory arrangement 210, a display device 215, an input/output (I/O) device 220, a transceiver 225, and other components 230 (e.g., an audio input device, an audio output device, a battery, a data acquisition device, ports to electrically connect the media player 150 to other electronic devices, etc.).

The processor 205 may be configured to execute a plurality of applications of the analysis server 135. For example, the processor 205 may execute a share application 235, an index application 240, and a weighting application 245. As will be described in further detail below, the share application 235 may determine a share value of the target audience, the share value being a percentage of a population. The index application 240 may determine an index value of the target audience, the index value being a likelihood that the target audience has a particular attribute. The weighting application 245 may utilize the outputs from the share application 235 and the index application 240 to generate the share-weighted index values.

It should be noted that the above noted applications being an application (e.g., a program) executed by the processor 205 is only exemplary. The functionality associated with the applications may also be represented as a separate incorporated component of the analysis server 135 or may be a modular component coupled to the analysis server 135, e.g., an integrated circuit with or without firmware. In yet another example, the functionality associated with the applications may be embodied in a multi-application service or gateway. In a particular manner, the functionalities may be a background operation such that a request for an attribute or recommendation may be input, the functionalities may be performed, and an outcome based on the results of the functionalities may be provided. Accordingly, a user may log into the service, input the request, and be provided the outcome (while the functionalities are utilized in a background capacity).

It should also be noted that the share application 235 and the index application 240 being configured to determine the share value and the index value, respectively, for an attribute of a target audience is only exemplary. The system 100 of FIG. 1 may incorporate one or more further components (e.g., connected to the communications network 115) that are configured to perform the functionalities of the share application 235 and the index application 240. Accordingly, the viewing behavior data from the survey devices 120-130 may be provided to the further components (e.g., rather than to the analysis server 135). The analysis server 135 may receive the outputs from the further components which may be the share values and the index values.

It should further be noted that the processor 205 may be configured to execute further applications. For example, results from the weighting application 245 of the share-weighted index values may be ranked or be configured into a graphical representation. Therefore, a user may be presented the share-weighted index values to analyze the target audiences or the television programs.

The memory arrangement 210 may be a hardware component configured to store data related to operations performed by the analysis server 135. Specifically, the memory arrangement 210 may store the data of the viewing behavior from the respondents (e.g., from the survey devices 120-130 or from a viewing diary). The display device 215 may be a hardware component configured to show data to a user. For example, the results from the weighting application 245 may be shown on the display device 215. The I/O device 220 may be a hardware component that enables the user to enter inputs. For example, the I/O device 220 may receive an input from a user (e.g., a television program) to show the results from the weighting application 245. The transceiver 225 may be a hardware component configured to transmit and/or receive data in a wired or wireless manner. Specifically, the transceiver 225 may be used with the communications network 115.

According to the exemplary embodiments, the analysis server 135 may determine the share-weighted index values based on share values and index values for target audiences of a population and/or television programs. Specifically, the share values and the index values may be for any type of target audience attribute related to the target audiences, the population, and/or the television programs. For example, the target audience attribute may be for a specific television program and ethnic groups who watch the specific television program. Instead of ethnic groups, the target audience attribute may also relate to age groups, gender groups, groups having a defined relationship status, etc. For illustrative purposes, ethnicities will be utilized herein. However, those skilled in the art will understand the interchangeability of this parameter. Accordingly, the target audience including various ethnicities may be a portion of the population who have watched the specific television program. The share value may indicate a percentage of each ethnicity of the target audience who have watched the specific television program. The index value may indicate a likelihood that a particular ethnicity will watch the specific television program. In another example, the target audience attribute may be for television programs being broadcast at a selected time (e.g., between 8:00 pm and 8:30 pm). Accordingly, the target audience may be a portion of the population who have tuned into any of these television programs. The share value may indicate a first percentage of the target audience who watched a first one of these television programs, a second percentage of the target audience who watched a second one of these television programs, etc. The index value may indicate a likelihood that the portion of the target audience who tuned into a select one of these television programs is likely to have watched this selected television program. In a further example, the target audience attribute may also incorporate other types of data such as psychographic and/or behavioral data in addition to demographics (e.g., views on religion, views on shopping/advertising, frequency of visits to a retail chain, etc.).

As will become apparent below, the share-weighted index values may be scaled such that the range of share-weighted index values may mirror each other to more accurately represent likelihoods and shares. Thus, the share-weighted index values that are highest (when taking an absolute value) have higher share values and higher index values whereas the share-weighted index values that are lowest (when taking an absolute value) have small share values and/or small index values. Therefore, the mechanism according to the exemplary embodiments compensate for attributes with very high index values but very low share values when determining results. Similarly, the mechanism according to the exemplary embodiments discount large share values that have index values close to average. Thus, attributes with a highest combination of share value and index value are emphasized for analysis purposes.

As described above, the share application 235 may determine a share value of the target audience. The share application 235 may utilize any mechanism to determine the share value of the target audience. For example, when the share value relates to ethnicities watching a specific television program, the share application 235 may receive the viewing behavior data of all respondents who watched the specific television program, identify the ethnicity of each respondent, and determine the percentages for each ethnicity to generate the share values. In another example, when the share value relates to television programs being broadcast at a particular time, the share application 235 may receive the viewing behavior data of all respondents who were watching television programs at the particular time, identify which of the television programs were being watched, and determine the percentages of each television program being watched to generate the share values. Those skilled in the art will understand that the share application 235 may utilize any manner of determining the share values.

As described above, the index application 240 may determine an index value of the target audience. The index application 240 may utilize any mechanism to determine the index value of the target audience. For example, when the index value relates to ethnicities watching a specific television program, the index application 235 may receive the viewing behavior data of all respondents who watched the specific television program, identify the ethnicity of each respondent, and utilize other information (e.g., historical viewing information to identify repeat viewing, polling information, etc.) to determine the likelihoods of each ethnicity to generate the index values. In another example, when the index value relates to television programs being broadcast at a particular time, the index application 240 may receive the viewing behavior data of all respondents who were watching television programs at the particular time, identify which of the television programs were being watched, and determine the likelihoods of each television program being watched to generate the index values. Those skilled in the art will understand that the index application 240 may utilize any manner of determining the index values.

As described above, the weighting application 245 may utilize the outputs from the share application 235 and the index application 240 to generate the share-weighted index values. The share-weighted index values may utilize a scaled index value based on the index value which is combined with the share value (e.g., as a product). Accordingly, the weighting application 245 may be configured to determine the scaled index value.

Initially, the index value is scaled since the index value ranges from 0 to infinity where an index value of 100 is a standard likelihood. Thus, the index value only includes 100 values that are below the standard likelihood to represent a lower likelihood while the index value includes an infinite number of values that are above the standard likelihood to represent a higher likelihood. For example, the index value for the higher likelihood may range in a realistic manner to 10,000. Thus, there may be 9,900 values that are above the standard likelihood. Furthermore, the meaning of an index value with reference to the standard likelihood may also be imbalanced. For example, an index value of 50 means that a target audience is half as likely to have an attribute whereas an index of 200 means the target audience is twice as likely to have the attribute. Thus, a negative change in index value of 50 has the same effect (e.g., halving) as a positive change in the index value of 100 (e.g., doubling). Accordingly, the exemplary embodiments are configured to re-scale the index value to a scaled index value so that an interpretation may be made on the same scale in both a positive direction and a negative direction. For example, a scaled index value of +0.5 and a scaled index value of −0.5 may be interpreted as equally more or less likely than the standard likelihood as well as being equidistant from the standard likelihood.

To scale the index value to generate the scaled index value, the weighting application 245 may utilize various scaling methods. For example, for an index value below 100 (i.e., the standard likelihood), a difference between the index value and 100 may be divided by 100 (i.e., ((Index−100)/100). Thus, the index values below 100 may be scaled akin to a share such as a percentage out of 100. When an attribute under-indexes against a population, the range of potential index values is already limited from 0 to 100. Thus, the scaled index values may range from −1.00 to 0.00.

In another example, for an index value above 100, a difference between the index value and 100 may be divided by the index value (i.e., ((Index−100)/Index). Thus, a range for the higher likelihood index values may be limited and creates a diminishing return once an index value exceeds five times the population average. Specifically, the scaled index values may range from 0.00 to +1.00. The limiting of the range for higher likelihood index values is used, because, above a certain index value, there are limited insights that may be gained beyond stating that the target audience is greatly over-indexed.

It is again noted that the index values, particularly the higher likelihood index values, exist on a theoretical scale up to infinity. Therefore, the viewing behavior data may likely have a different maximum index. By employing the above described formula to generate the scaled index value for a higher likelihood index value, the potential long range of potential outliers may be eliminated. For example, when a normal distribution of index values above 100 is graphically represented on a boxplot, there is a narrow range of index values compared to a wide spread of outlier index values as each outlier is represented in the boxplot. However, these outliers are still represented in the boxplot and may be represented with an undue size to show their presence. For example, the vast majority of index values may range from between 100 to 400 but there may be many outliers above 750 ranging up to 4,600 that are still shown in the boxplot which may result in a median value to be over 700. Such a representation places too much weight on the outliers and will therefore overstate any relationship of the outliers. Those skilled in the art will understand that without scaling, the outliers increase a difficulty or eliminate a possibility of finding a relationship by obscuring the data being represented in the boxplot.

In contrast, when a distribution of the scaled index values for index values above 100 is graphically represented on a boxplot, a more normal distribution is represented. Specifically, the vast majority of scaled index values may range from between 0.31 to 0.74with a median value of 0.57. Therefore, the share-weighted index values that are generated may provide a useful feature when visually reading the results. Specifically, the results may be illustrated in a list or a selection of an attribute that defines a target audience may be made. For example, with ethnicity data, an analyst may examine five rows of data formatted for the results to make a decision. In contrast, without scaling the index values, the data may include a long tail of outliers which creates a significant number of rows that do not provide a substantial amount of information but is still included. The analyst may have to wade through these tails to make an informed decision about each attribute. Therefore, through the scaled index values in generating the share-weighted index values, an improved manner to rank attributes is provided through the exemplary embodiments.

It is noted that the above formulas may be utilized for any index value. However, an index value of 100 may utilize either formula. Although an index value of 100 may be apparent when viewing an output of index values that are not scaled, the scaled index value corresponding to 100 may mask what is actually being represented by such an index value, particularly when further considering the associated share value. Therefore, the weighting application 245 may also modify the manner in which the scaled index values are generated based on various considerations.

In a first consideration, when the index value is exactly 100, the scaled index value is calculated as zero which is misleading (e.g., to model in a graphical representation of results). For example, a target audience attribute with a very high share value but an index value of 100 should be discounted because the index value corresponds to an average or standard likelihood. However, the target audience attribute should not be entirely disregarded due to its high share value. Therefore, the weighting application 245 may utilize a modified approach to generating the scaled index value for a target audience attribute whose index value is 100 based on the share value. Specifically, when the share value is relatively low, the scaled index value may remain as zero. When the share value is relatively high, the scaled index value may be set or overwritten to 0.01 to create a near-zero scaled index value that is not subject to the peculiar properties of representing zero in results. In a particular embodiment, the weighting application 245 may utilize a threshold value to determine whether the share value is low or high. For example, the threshold value may be 50%. Thus, if the share value is below 50%, the scaled index value for a target audience attribute having an index value of 100 may be zero. If the share value is or above 50%, the scaled index value for the target audience attribute having an index value of 100 may be 0.01.

It is noted that the use of an index value of 100 being a standard likelihood is only exemplary. That is, the index value of 100 may represent any standard likelihood. For example, the standard likelihood may be a value lower (e.g., 90) or greater (e.g., 110) than the index value of 100. Thus, the index value of 100 may represent any selected value indicative of a standard likelihood. The exemplary embodiments may be modified accordingly.

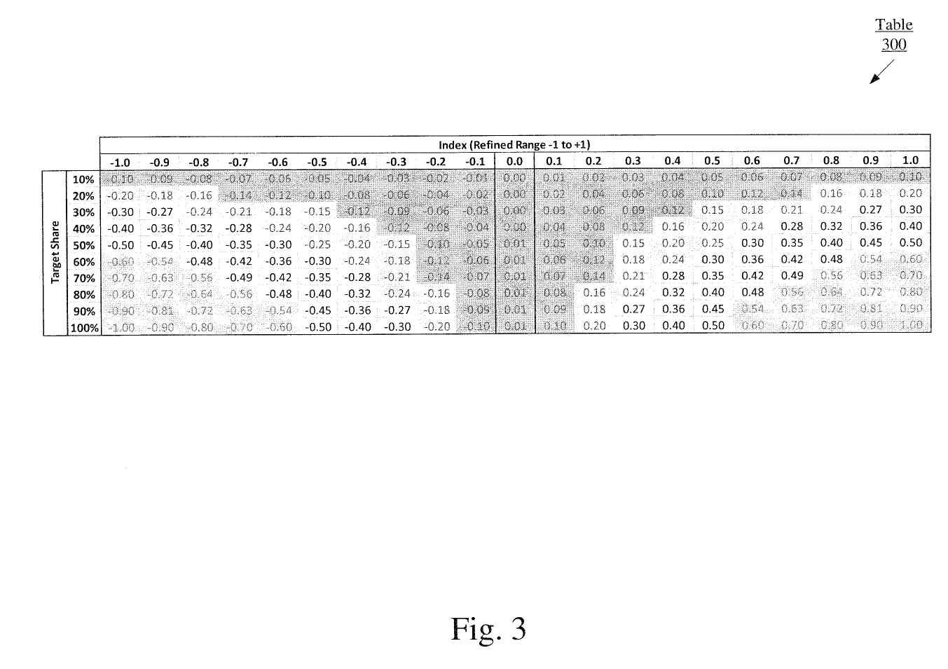

FIG. 3 shows a table 300 of share-weighted index values according to the exemplary embodiments. Specifically, the share values are shown in rows while the scaled index values are shown in columns. Thus, each cell represents the share-weighted index values for a given share value and a scaled index value. Again, the scaled index value may be determined using the corresponding formula described above. Specifically, for index values between 0 to 100, the formula dividing by 100 may be used. For index values between 100 to infinity, the formula dividing by the index value itself may be used. Using these scaled index values, the share-weighted index value may be determined as a product between the scaled index value and the share value. For example, a scaled index value of 0.5 and a share value of 70% has a share-weighted index value of 0.35.

The table 300 also illustrates the first consideration described above for index values of 100. Again, when a target audience attribute has an index value of 100, the scaled index value is calculated as zero. Using the above described threshold value for a share value as 50%, the table 300 shows that the scaled index value for an index value of 100 for share values of 10%, 20%, 30%, and 40% is as calculated—zero. The table also shows that the scaled index value for an index value of 100 for share values of 50%, 60%, 70%, 80%, 90%, and 100% is overwritten to 0.01. In this manner, the table 300 represents the possible share-weighted index values.

The weighting application 245 may incorporate further considerations. Those skilled in the art will understand that index values between 80 and 120 are considered fair share index values. That is, the target audience attribute with such an index value is likely not statistically significantly different from the attribute associated with the population. As fair share index values, any index value in the range between 80 and 120 should be treated as “average”. While an index value of 99 technically means that the target audience is 1% less likely than the population to have an attribute, the exemplary embodiments as described above generates a scaled index value of —0.01. Accordingly, a negative value may be assigned for index values between 80 and 100 whereas a proper positive value may be assigned for index values between 100 and 120. This creates an accurate final share-weighted index value (through a product with the corresponding share value) with the wrong sign. In reality and for analysis purposes, the scaled index value for index values between 80 and 100 should be treated as “fair share”.

Therefore, in a second consideration, the weighting application 245 re-evaluates generating scaled index values for index values between 80 and 120 such that a proper representation may be provided for such index values. In particular, as index values between 100 and 120 have a proper positive scaled index value, the weighting application 245 may utilize a modified approach in generating the scaled index value for index values between 80 and 100. Specifically, an absolute value may be taken from the calculation to determine the scaled index value for index values between 80 and 100. For example, an index value of 92 is calculated to have a scaled index value of −0.08 (the correct value but the wrong sign because it falls within the “fair-share” index value range). Utilizing the modified approach, the weighting application may utilize the formula (Abs(Index−100)/100) for any index value between 80 and 100 such that the index value of 92 has a scaled index value of +0.08.

It is noted that the use of index values between 80 and 120 as “fair-share” index values is only exemplary. Those skilled in the art will understand that the fair-share index value range may be different, particularly when different factors are used in determining what constitutes an average likelihood. Thus, the fair-share index value range of 80 to 120 may represent any range of values indicative of a fair-share. The exemplary embodiments may be modified accordingly.

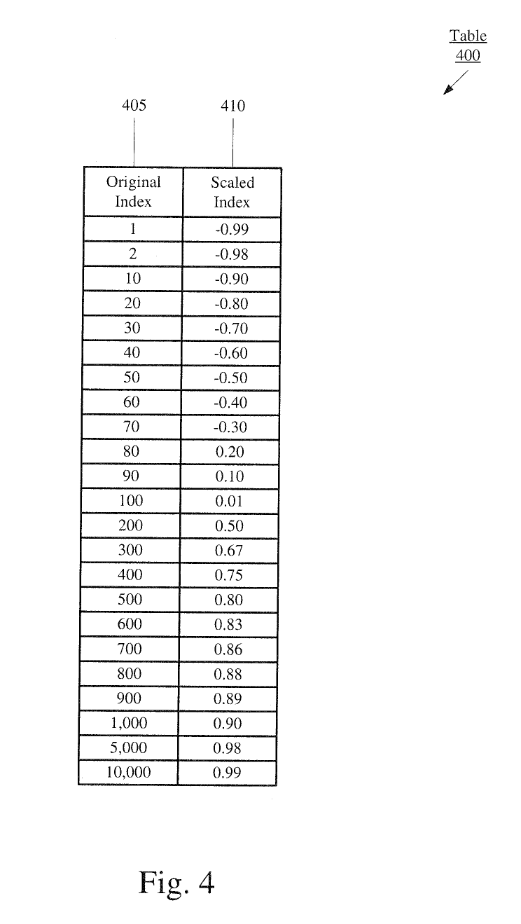

FIG. 4 shows a table 400 of modified scaled index values according to the exemplary embodiments. Specifically, the column 405 is a set of index values (e.g., as received from the index application 240). The column 410 is a set of corresponding scaled index values. The table 400 assumes that the share value is above the predetermined threshold (e.g., 50%) such that the scaled index value for an index value of 100 is 0.01. However, it is again noted that when the share value is below the predetermined threshold or the above described first consideration is not incorporated, the scaled index value for an index value of 100 may be zero.

By incorporating the first consideration, the table 400 shows how the index values are used to generate the scaled index values using the four manners described above. Specifically, when the index value is between 0 and 80, the formula (Index−100)/100 is used to generate the scaled index value. When the index value is between 80 and 100, the formula Abs(Index−100)/100 is used to generate the scaled index value. When the index value is 100 and the share value is below the predetermined threshold, the scaled index value is zero whereas when the index value is 100 and the share value is above the predetermined threshold, the scaled index value is overwritten to 0.01. When the index value is above 100, the formula (Index −100)/Index is used to generate the scaled index value. Thus, the share-weighted index value is determined as a product of the scaled index value and the corresponding share value.

The table 400 also illustrates in column 410 that the scaling of the index values normalizes any degree of difference. As described above, an index value of 50 may represent a likelihood that is half of the standard likelihood (having an index value of 100) while an index of 200 represents a likelihood that is twice of the standard likelihood. The degree of difference with un-scaled index values includes only a difference of 50 in the index scale for half as likely while a difference of 100 in the index scale for twice as likely. With half as likely being an equivalent difference in the opposite direction as twice as likely relative to the standard likelihood, the un-scaled index values have different amounts to represent these differences. In contrast, the scaling operation performed on the index values enables common distances to represent equivalent differences. Specifically, assuming the standard likelihood is not overwritten and is set to 0, half as likely is represented with a scaled index value of −0.5 while twice as likely is represented with a scaled index value of +0.5 —the same distance from the standard likelihood.

The analysis server 135 may provide the share-weighted index values to a user who requests the results for a target audience attribute. In this manner, the user is not required to interpret the share values and the index values used in generating the share-weighted index values. The user is also not required to interpret the share values in view of the index values or vice versa. The analysis server 135 may also include further operations that utilize the share-weighted index values. For example, the analysis server 135 may receive a request from the user for selecting a target audience or a television program. Based on the share-weighted index values, the analysis server 135 may appropriately provide a result or a set of results for the request. Therefore, the analysis server 135 may provide an automated selection process for requests from a user. The selection process may be for a variety of different types of requests. In a first example, the request may be the psychographic traits that are most significant descriptors of a target audience. In a second example, the request may be the television programs that are consumed or watched disproportionately more (or less) by a target audience over a population. In a third example, the request may be musical artists that are consumed or listened to disproportionately more (or less) by a target audience over a population. As those skilled in the art will understand, the request may relate to any topic in which a target audience attribute for a target audience is compared to a population, another target audience, a plurality of target audiences, etc. The share-weighted index values may be used to provide responses to the requests.

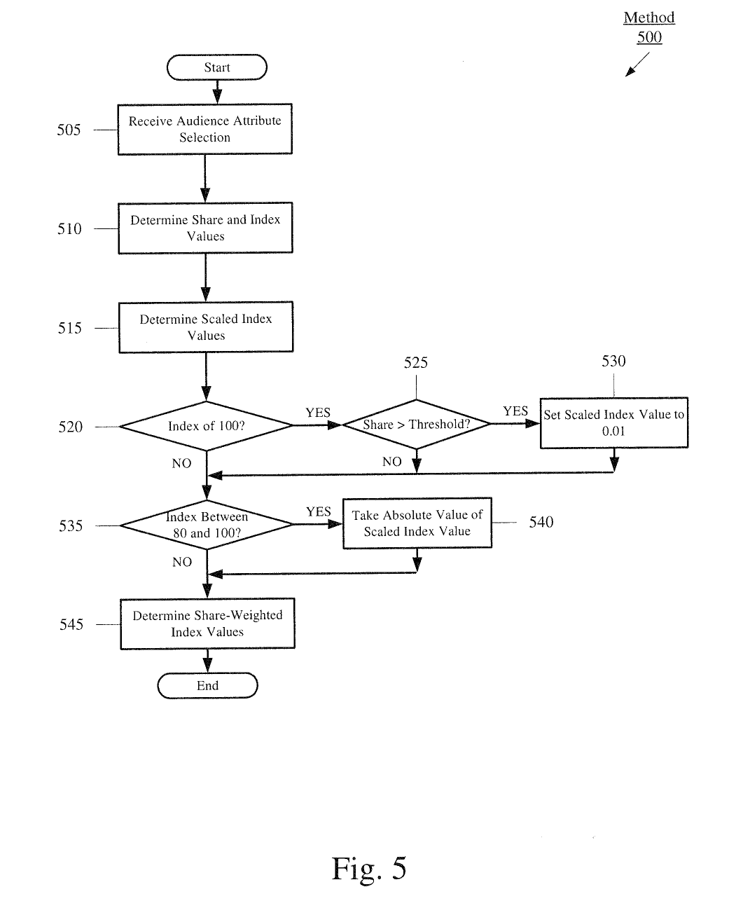

FIG. 5 shows a method 500 of determining share-weighted index values according to the exemplary embodiments. The method 500 relates to utilizing share values and index values to generate the share-weighted index values. The method 500 will be described from a perspective of the analysis server 135. The method 500 will be described with regard to the system 100 of FIG. 1 and the analysis server 135 of FIG. 2.

In step 505, the analysis server 135 receives a request. Specifically, the request may relate to a selection for a target audience attribute. As described above, the request may relate to any topic for which the share values and the index values may be used to measure a relativity between one or more target audiences to a population or other target audiences. For example, the request may be to recommend a television program to advertise to a target audience.

In step 510, the analysis server 135 determines the share value and the index value associated with the request. For example, if the request relates to the ethnicity breakdown for a particular television program, the share values and index values corresponding to each ethnicity may be determined for the target audience who watched the particular television program. As described above, any mechanism may be used in determining the share values and the index values. Furthermore, it is assumed that the analysis server 135 is configured with the share application 235 and the index application 240 to determine the share values and the index values, respectively. However, it is again noted that the analysis server 135 may also be configured to receive the share values and the index values from a further component or components configured for the functionalities of the share application 235 and the index application 240.

In step 515, the analysis server 135 determines the scaled index values for the index values determined in step 510. As described above, the index value may be scaled into the scaled index value using one of two formulas based on whether the index value is below 100 or equal to/above 100. If the index value is below 100, the analysis server 135 may utilize the formula (Index−100)/100 while if the index value is equal to or above 100, the analysis server 135 may utilize the formula (Index−100)/Index.

In step 520, the analysis server 135 determines whether any of the index values is 100. As described above, the analysis server 135 may incorporate various considerations for index values that have peculiar properties and/or misrepresent its worth, particularly from conversion into a scaled index value. One such consideration is when the index value is 100 since the formulas used in converting the index value to the scaled index value results in zero. It is again noted that the use of the index value of 100 representing a standard likelihood is only exemplary. If no index value is 100, the analysis server 135 continues the method 500 to step 535, which is described below.

If there is at least one index value that is 100, the analysis server 135 continues the method 500 to step 525. In step 525, the analysis server 135 identifies the corresponding share value for the index value that is 100 and determines whether the share value is above a predetermined threshold. As described above, the index value of 100 should be discounted but not always disregarded, particularly when the share value is above the predetermined threshold such as 50%. If the index value of 100 has a share value under the predetermined threshold, the analysis server 135 continues the method 500 to step 535 and the scaled index value remains zero. However, if the index value of 100 has a share value over the predetermined threshold, the analysis server 135 continues the method 500 to step 530 where the analysis server 135 sets or overwrites the scaled index value to 0.01.

In step 535, the analysis server 135 determines whether any of the index values is between 80 and 100. As described above, another consideration is whether the index value corresponds to a fair share index value. Specifically, the fair share index values may range from 80 to 120. Therefore, applying a negative sign for a scaled index value that corresponds to a fair share index value misrepresents the meaning of the index value. It is again noted that the use of index values between 80 and 120 representing a fair-share is only exemplary. If no index value is between 80 and 100, the analysis server 135 continues the method 500 to step 545, which is described below. If there is at least one index value that is between 80 and 100, the analysis server 135 continues the method 500 to step 540. In step 540, the analysis server 135 takes an absolute value of the scaled index value that is based on an index value between 80 and 100. Accordingly, any scaled index value that is negative for an index value between 80 and 100 is overwritten as a positive scaled index value having the same magnitude. That is, the analysis server 135 may utilize the formula Abs(Index−100)/100.

In step 545, the analysis server 135 determines the share-weighted index values as a product of the scaled index value and the corresponding share value. Using the above example in which the request is to recommend a television program to advertise, the analysis server 135 may determine which of the television programs that are analyzed has a highest share-weighted index value. The identified television program may be recommended or a plurality of television programs having the highest share-weighted index values may be recommended.

The method 500 described above incorporates a first consideration of modifying an index value of 100 and a second consideration of modifying index values between 80 and 100. However, as described above, the considerations may factors that may be included into the method 500. Thus, if no considerations are to be used, the method 500 may utilize steps 505-515 and 545. If only the first consideration is to be used, the method 500 may utilize steps 505-530 and 545. If only the second consideration is to be used, the method 500 may utilize steps 505-515 and 535-545.

It should again be noted that the determination and the use of the share values and the index values is only exemplary. In the system 100 described above or when further components are included in the system 100 that determine share values and index values, the underlying components utilizing mechanisms associated with share values and index values may be maintained. That is, the original functionalities of receiving viewing behavior data, generating index values and share values of target audiences, and receiving/utilizing the values may be maintained. However, the use of the share values and index values is only exemplary. That is, utilizing a separate process in which the share values and index values is only exemplary. The exemplary embodiments may be modified such that the viewing behavior data may be received and the share-weighted index values may be determined such that the share values and the index values are incorporated into the process rather than being determined in a separate manner.

The exemplary embodiments may be utilized for a variety of different reasons where how a target audience is different from a population is to be shown. In a first example, the television related requests and results described in detail above may be utilized by various outlets such as television development entities, advertisement entities, etc. In a second example, an entity may be attempting to reach a target audience of a particular age and gender with a new advertisement campaign. Based on the results of the share-weighted index values, the entity may reach the target audience by trafficking the advertisement on media outlets that the target audience is likely to view. Specifically, media outlets may be re-ranked using the share-weighted index values and a top list of media outlets may be provided as recommendations. In a third example, a consumer product entity may wish to sell a product to a specific target audience. The consumer product entity may receive a list of retailers having higher share-weighted index values to which the product should be sold to maximize exposure of the product to the target audience and minimize exposure to other audiences (e.g., selling a high-end product at a lower end retail outlet versus a higher end retail outlet).

The exemplary embodiments provide a device, system, and method for determining share-weighted index values based on share values and index values for a target audience. The share-weighted index values may accurately represent a target audience attribute through a scaled index value. The scaled index value uses a scale in which a lesser likelihood and a higher likelihood mirror one another along the scale. A product between the scaled index value and the share value may be used to determine the share-weighted index value.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system such as Microsoft Windows, a Mac platform and MAC OS, a mobile device having an operating system such as iOS or Android, etc. In a further example, the exemplary embodiments of the above described method may be embodied as a program containing lines of code stored on a non-transitory computer readable storage medium that, when compiled, may be executed on a processor or microprocessor.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalent.

1. A method, comprising:
in an analysis server:
determining a share value and an index value for an attribute of a target audience, the share value indicative of a percentage that the target audience occupies in a population, the index value indicative of a likelihood that the target audience has the attribute;
determining a scaled index value based on the index value, the scaled index value being determined with a first formula when the index value is below a predetermined threshold index value, the scaled index value being determined with a second formula when the index value is above the predetermined threshold index value; and
determining a share-weighted index value based on the share value and the scaled index value.

2. The method of claim 1, wherein the share-weighted index value is a product of the share value and the scaled index value.

3. The method of claim 1, wherein the predetermined threshold index value is 100.

4. The method of claim 3, wherein the first formula is:
(I−100)/100, where I is the index value.

5. The method of claim 3, wherein the second formula is:
(I−100)/I, where I is the index value.

6. The method of claim 3, wherein the scaled index value ranges between −1 and +1.

7. The method of claim 1, further comprising:
determining whether the index value is 100; and
setting the scaled index value to 0.01 when the share value is above a predetermined threshold share value.

8. The method of claim 7, wherein the predetermined threshold share value is 50%.

9. The method of claim 1, further comprising:
determining whether the index value is between 80 and 100; and
setting the scaled index value to an absolute value thereof.

10. The method of claim 1, further comprising:
receiving a user request associated with the attribute for the target audience; and
determining a response for the user request based on the share-weighted index value.

11. An analysis server, comprising:
a transceiver receiving a share value and an index value for an attribute of a target audience, the share value indicative of a percentage that the target audience occupies in a population, the index value indicative of a likelihood that the target audience has the attribute; and
a processor determining a scaled index value based on the index value, the scaled index value being determined with a first formula when the index value is below a predetermined threshold index value, the scaled index value being determined with a second formula when the index value is above the predetermined threshold index value, the processor determining a share-weighted index value based on the share value and the scaled index value.

12-17. (canceled)

18. The analysis server of claim 26, wherein the predetermined threshold share value is 50%.

19. The analysis server of claim 11, wherein the processor further determines whether the index value is between 80 and 100 and sets the scaled index value to an absolute value thereof.

20. A method, comprising:
in an analysis server:
determining a share value and an index value for an attribute of a target audience, the share value indicative of a percentage that the target audience occupies in a population, the index value indicative of a likelihood that the target audience has the attribute;
determining a scaled index value based on the index value, the scaled index value being determined with a first formula when the index value is below a predetermined threshold index value, the scaled index value being determined with a second formula when the index value is above the predetermined threshold index value; and
determining a share-weighted index value based on the share value and the scaled index value,
wherein, when the index value is 100, the scaled index value is set to 0.01 when the share value is above a predetermined threshold share value, and
wherein, when the index value is between 80 and 100, the scaled index value is set to an absolute value thereof.

21. The analysis server of claim 11, wherein the share-weighted index value is a product of the share value and the scaled index value.

22. The analysis server of claim 11, wherein the predetermined threshold index value is 100.

23. The analysis server of claim 22, wherein the first formula is:
(I−100)/100, where I is the index value.

24. The analysis server of claim 22, wherein the second formula is:
(I−100)/I, where I is the index value.

25. The analysis server of claim 22, wherein the scaled index value ranges between −1 and +1.

26. The analysis server of claim 11, wherein the processor further determines whether the index value is 100 and sets the scaled index value to 0.01 when the share value is above a predetermined threshold share value.
